(19) United States
(12) Patent Application Publication
(10) Pub. No.: US 2026/0202240 A1
(43) Pub. Date: Jul. 16, 2026

(54) SYSTEMS AND METHODS FOR OPTICAL TIME DOMAIN REFLECTOMETRY BASED DISTRIBUTED ACOUSTIC SENSING USING DELAYED OPTICAL PULSES

(71) Applicant: RAMOT AT TEL-AVIV UNIVERSITY LTD., Tel Aviv (IL)

(72) Inventors: Eran BURSTEIN, Tel Aviv (IL); Nadav ARBEL, Tel Aviv (IL); Avishay EYAL, Tel Aviv (IL)

(21) Appl. No.: 19/133,740

(22) PCT Filed: Dec. 3, 2023
(86) PCT No.: PCT/IL2023/051236

§ 371 Date: May 29, 2025

Related U.S. Application Data
(60) Provisional application No. 63/385,995, filed on Dec. 5, 2022.

(51) Int. Cl. G01H 9/00; G01D 5/353

(52) U.S. Cl. CPC G01H 9/004; G01D 5/35361

(57) ABSTRACT

A distributed acoustic sensing (DAS) system that is configured to generate, at each scan period, at least two corresponding optical pulses such as a first pulse and a second pulse, where the pulses are of equivalent (similar or same) optical characteristics and cause a time-delay between those at least two pulses for example by directing each of the pulses through a different optical fiber of different fiber lengths, such as to form a time difference Δt between those at least two pulses. Each of the generated pulses may be directed through a sensing optical fiber of the DAS system, where one or more optical characteristics of (e.g., Rayleigh) backscattered light returned from the sensing optical fiber can be detected for determination of one or more updated properties of acoustic wave(s) influencing the sensing optical fiber for detection of acoustical influences such as mechanical strains, acoustic vibrations etc.

### TECHNICAL FIELD

The invention generally relates to distributed acoustic sensing (DAS) and more particularly to optical time-domain reflectometry (OTDR) based DAS.

### BACKGROUND

Distributed Acoustic Sensing (DAS) is a fiber optic sensing technology in which an optical fiber is used for sensing signals such as acoustic signals, dynamic strain, vibrations, seismic signals, etc., typically over long distances.

Some DAS systems are based on Optical Time Domain Reflectometry (OTDR) using operation principles that typically involve launching a pulse of light into an optical fiber, and measuring Rayleigh backscattered light at the output point of the optical fiber from which the optical pulse is injected (hence “backscattered light”), using one or more optical receivers and data acquisition device(s) such as an oscilloscope. The amount of light which returns from each location along the fiber is a random quantity which depends on the Rayleigh backscattering (RBS) level at this (input) location. This level is determined via interference of light components which return from a resolution cell at this position to the receiver. It depends mainly on the exact configuration of RBS in this position in the fiber and on the frequency/wavelength of the pulsed light. When a section of the fiber experiences strains e.g., caused by acoustical signals, seismic signals and/or vibrations the RBS level in the corresponding fiber section changes and this can be detected at the receiver.

The location of the (mechanical/acoustical) strain applied to the fiber is inferred from the roundtrip time elapsed between the transmission of the pulse and the return of the RBS.

Current DAS systems generally utilize ultra-coherent lasers, with linewidths of ~1 kHz or less, for fiber interrogation implementation. There are two requirements which the laser needs to satisfy in order to be suitable as a source in a DAS interrogator:
(i) The first requirement is that the bandwidth of the laser (transmitter) pulse will not be broader than the bandwidth of the optical receiver. This guarantees that the detected signal at each scan period will not be averaged out and will maintain its high contrast. The high contrast of the detected signal is required for having high strain sensitivity.
(ii) The second requirement is that the output frequency or wavelength (WL) of the laser will remain constant from one scan to the next (WL or frequency coherence). If this condition is not satisfied the Rayleigh scattering from the fiber will vary due to the frequency variations of the laser and these variations will obscure the sought strain-induced variations. This condition requires ultra-coherent lasers which maintain stable instantaneous frequency over large time periods (e.g., >>1 ms).

### SUMMARY

Embodiments of the present invention may pertain to a distributed acoustic sensing (DAS) system comprising at least:
(i) a sensing optical fiber;
(ii) a pulse generation subsystem configured to generate, at each scan period, two or more corresponding optical pulses of equivalent (e.g., same or similar) optical characteristics, where the different corresponding optical pulses may be time delayed in respect to one another; and
(iii) a detection subsystem comprising at least one detector, configured and positioned to detect one or more optical characteristics of backscattered light returned from the sensing optical fiber;
(vi) a processor configured at least to determine, based on detected backscattered signals of each of the corresponding pulses, one or more updated properties of the acoustic waves which influence the sensing optical fiber such as by applying mechanical/acoustic forces/strains/vibrations over the sensing optical fiber.

According to some embodiments, the pulse generation subsystem may include at least:
(a) an optical source unit comprising one or more optical sources, configured for generating pulses of optical signals; and
(b) at least two optical fibers: a first fiber of a first fiber length L1 and a second fiber of a second fiber length L2, wherein the first and second fibers are of different fiber-lengths such that |L2−L1|=ΔL, wherein the generated first pulse of each generated corresponding pair of pulses is directed through the first fiber and the second pulse is directed through the second fiber, for causing the time delay Δt between the two pulses, for detecting one or more backscattering properties thereof.

Aspects of disclosed embodiments pertain to a method for distributed acoustic sensing (DAS), the method including at least:
providing a DAS system according to any one or more of claims 1 to 13;
at each scan period:
generating two corresponding pulses: a first pulse and a second pulse, forming a time delay Δt between the two corresponding pulses Δt;
directing each of the first and the second corresponding pulses through the sensing optical fiber;
detecting backscattered signals of each pair of corresponding first and second pulses returning from the sensing optical fiber; and
determining, based on detected backscattering signals of each pair of corresponding pulses, one or more updated properties of the acoustic wave which interacts with the sensing optical fiber.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIGS. 1A and 1B show main components of a DAS system or part thereof that generates delayed pulses for performing DAS over a sensing optical fiber, according to some embodiments: FIG. 1A shows a block diagram of the DAS system; and FIG. 1B shows components of a pulses generation subsystem, according to some embodiments;

FIG. 2 schematically illustrates a DAS system that uses an unbalanced Mach Zehnder Interferometer (MZI) with two optical fibers of different fiber lengths to generate time delay between corresponding pulses, according to other embodiments;

FIG. 3 is a block diagram schematically illustrating main components of a DAS system that is configured also for generating corresponding pulses with differential time delay, according to additional embodiments;

FIGS. 4A and 4B schematically illustrate a DAS system with a stable reflective configuration using a Faraday reflector, according to some embodiments: FIG. 4A shows the DAS system without using optical amplifiers; and FIG. 4B shows the DAS system with optical amplifiers being used for signal to noise ratio (SNR) improvement;

FIG. 5 schematically illustrates a DAS system with a homodyne detection scheme, according to other embodiments.

FIGS. 6A and 6B schematically illustrate a general DAS system configuration for implementing DAS via an error signal of optical telecom links by using separated transmitter and receiver, according to some embodiments: FIG. 6A shows a DAS system using two servers; and FIG. 6B shows a DAS system using a closed loop configuration and single processor/server associated with both an optical receiver and transmitter of the DAS system co-located in respect to one another;

FIG. 7 schematically illustrates a general DAS system configuration for implementing DAS via an error signal of optical telecom links by using co-located transmitter and receiver, according to other embodiments;

FIG. 8 is a flowchart, schematically illustrating a method for distributed acoustic sensing by generation of corresponding time-delayed signals, according to some embodiments;

FIGS. 9A and 9B show graphs of Rayleigh profiles of two corresponding pulses generated by a DAS system of some embodiments: FIG. 9A shows Rayleigh profiles of the two time-delayed optical pulses directed through a sensing (optical) fiber; and FIG. 9B shows a graph simulating difference signal intensity (in Volts) in respect to position of an acoustical disturbance in a specific position in the sensing fiber; and

FIG. 10 shows a simulated dependency of an optimal length-difference indicative of corresponding optimal time delay between the pulses, and frequency of the external acoustic signal, according to some embodiments.

### DETAILED DESCRIPTION OF EMBODIMENTS

In the following detailed description, different specific details are set forth in order to provide a thorough understanding of the presently disclosed subject matter. However, it will be understood by those skilled in the art that the presently disclosed subject matter may be practiced without these specific details and/or require more known in the art components for full implementation of the disclosed invention(s). In other instances, well-known methods, systems, procedures, and components have not been described in detail so as not to obscure the presently disclosed subject matter.

Aspects of disclosed embodiments, pertain to a distributed acoustic sensing (DAS) system that uses two or more corresponding light pulses of equivalent (same or similar) optical characteristics that are injected into and guided through a sensing optical fiber (herein also “sensing fiber”), where one of the two corresponding pulses is time-delayed in respect to the other pulse forming a time delay Δt between these two corresponding pulses for improving measuring of backscattered light from the sensing fiber for DAS based detection/determination of one or more properties of the acoustic signal which interact with the sensing fiber, even in cases in which the one or more light sources used for generating the pulsed light is of low or moderate coherence and/or low/moderate WL/frequency peak/linewidths stability. In this way a laser pulse with a bandwidth as high as 1 GHz can be used for interrogating the sensing fiber provided the detector is the same bandwidth. In fact, according to the disclosed method the bandwidth of the laser pulse can be arbitrarily broad as long as the detector has the same bandwidth.

According to some embodiments at each scan period of the DAS system, the two or more corresponding pulses are of equivalent optical characteristics such as same/identical or similar/proximal frequency/WL peak, instantaneous frequency variations, WL bandwidth, modulation, intensity profile and polarization direction.

According to some embodiments the acoustic/vibrations signals can be detected based on differences in Rayleigh backscattered signals/profiles of the two time-delayed corresponding pulses guided through the sensing fiber. using one or more optical time-domain reflectometry (OTDR) devices and/or techniques to determine one or more optical characteristics of the sensing fiber per each of the corresponding time-delayed pulses that can be used for determining corresponding one or more acoustical (e.g. mechanical) perturbations related characteristics/properties.

The term “time-delayed” used herein in respect to corresponding (optical) pulses may be defined as pulses that are delayed in respect to one another only either because they are passed through optical fibers of different fiber-lengths thereby travel different optical path lengths (OPLs) or by using any other time-delaying technique.

Ideally, in the absence of noise or variations in the Rayleigh backscatter (RBS) signal, the difference signal should be zero at all times. Any acoustically induced variation in the Rayleigh backscatter signal will induce variations in the difference signal. Since the sensing fiber is interrogated with two identical pulses, the variation of the instantaneous frequency of the laser from one scan to the next, does not lead to variations in the difference signal and does not adversely affect the measurement. In fact, since the variations in the instantaneous frequency of the light source being used can alter the obtained Rayleigh profile of the sensing fiber, a measurement may be performed with many different Rayleigh profiles and this can mitigate the issue of Rayleigh fading.

The time difference “Δt” between the first and second corresponding pulses may have to be equal to or larger than the time required for a corresponding/equivalent pulse to travel twice the length of the sensing optical fiber such that Δt≥2Lsf/ν, where “Lsf” is the length of the sensing optical fiber and “ν” is the speed of light in the sensing optical fiber.

According to some embodiments, the time-difference between each pair of generated corresponding pulses may be achievable by using an unbalanced Mach Zehnder Interferometer (MZI).

One optional objective of proposed embodiments, is to enable performing high-quality DAS without necessarily using ultra-coherent lasers allowing implementation of OTDR based DAS with light sources (e.g., laser devices) of much shorter coherence lengths which may dramatically reduce costs and enable, for example, deployment of more DAS systems within a specific area to be measured for detection and identification of various acoustic perturbations, dynamic strains, seismic signals, vibrations, etc.

Aspects of disclosed embodiments, pertain to a DAS system that may include at least:
a pulse generation subsystem including one or more pulsed light sources, configured for generating pulses of optical signals;
a sensing optical fiber;
a delay optical fiber;
wherein at each scan/measuring period, the pulse generation subsystem generates two corresponding pulses: a first pulse and a second pulse, wherein the second pulse is directed through the delay optical fiber such as to form a time difference Δt between the first pule and the second pulse, which may be directed to a corresponding first optical fiber which may be significantly shorter than the delay optical fiber, wherein both the first and the second corresponding pulses are injected into and directed through the sensing optical fiber;
a detection subsystem comprising at least one detector, the detection subsystem being located and configured at least to detect backscattered signals of each pair of corresponding first and second pulses; and
at least one processor (which may be embedded as part of the detection subsystem) configured at least to determine, based on detected backscattering signals of each pair of corresponding pulses and determine, one or more updated properties of the acoustic wave which interacts with the sensing fiber.

According to some embodiments, the detection subsystem and/or the processing unit may be configured at least to determine Rayleigh profile of the sensing fiber for each of the corresponding pulses at each scan, for determining the one or more updated properties of the acoustic wave which interacts with the sensing fiber.

It is noted the terms “optical fiber” and “fiber” and/or the terms “delay optical fiber” and “delay fiber” may be interchangeably used herein.

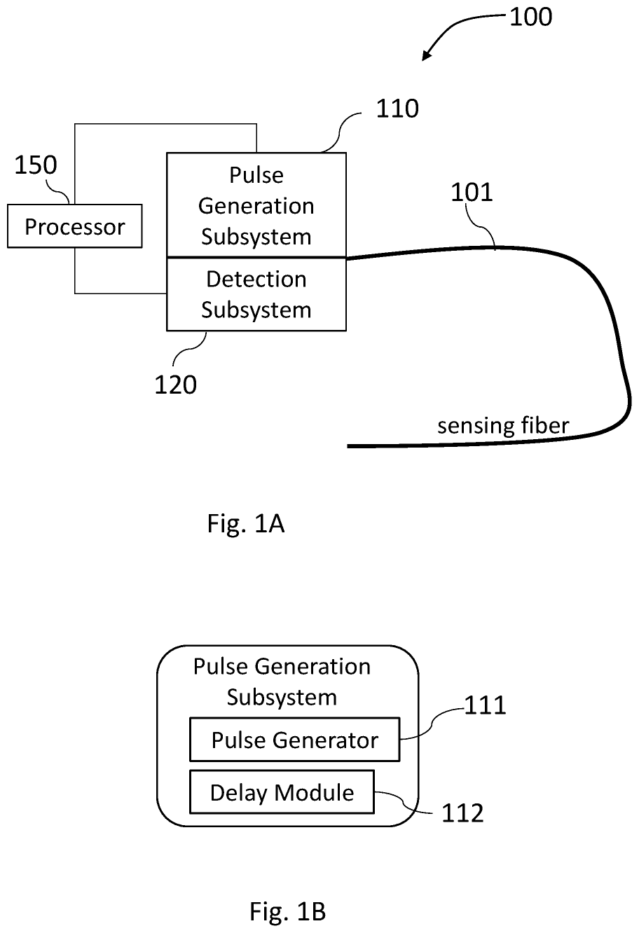

Reference is now made to FIGS. 1A-1B showing a general block diagram of a DAS system 100, according to some embodiments. The system may include at least:
(i) a pulse generation subsystem 110 including one or more pulsed light sources such as one or more modulated pulsed light sources, positioned and configured to form for each scanning/measuring session/event a pair of two equivalent optical pulses that are time-delayed, forming a time difference “At” therebetween;
(ii) a sensing fiber 101, which is an optical fiber of length “L” deployed over a specific area to be acoustically measured;
(iii) a detection subsystem 120 including at least one optical receiver/detector/sensor optionally located at the input port of the sensing fiber 101 from which the generated pulses are injected into the sensing fiber 101, such as to measure/detect/sense one or more optical characteristics of light backscattered/retuned from the sensing fiber 101; and
(iv) processor 150 for receiving or retrieving sensor data from the detection subsystem and processing the sensor data to determine one or more acoustical properties of the sensing fiber 101 or environment thereof, e.g., based on comparison between one or more optical characteristics/behaviors of the two Rayleigh backscattered signals/profiles.

The pulse generation subsystem 110 may include a pulse generator 111 that includes the one or more pulsed light sources such as a modulated continuous wave (CW) laser device for forming pairs of first and second corresponding light pulses of equivalent optical characteristics, and a delay module 112 that is configured and located to delay each of the generated first and second corresponding pulses such as to form a time delay Δt therebetween before these corresponding pulses are injected into and guided through the sensing fiber 101.

The manner in which the actual time delay can be implemented and the optional components of the delay module 112 may vary and also depend on optical and/or other physical characteristics of the sensing fiber. For example, on whether or not the sensing fiber 101 is an already in-use optical communication cable or a designated sensing fiber, specially designed for DAS purposes.

According to some embodiments, the delay module 112 may include two different optical fibers: a first fiber for guiding the first generated pulse therethrough and a second fiber for guiding the corresponding second pulse therethrough, where the first and second fibers are of different fiber lengths.

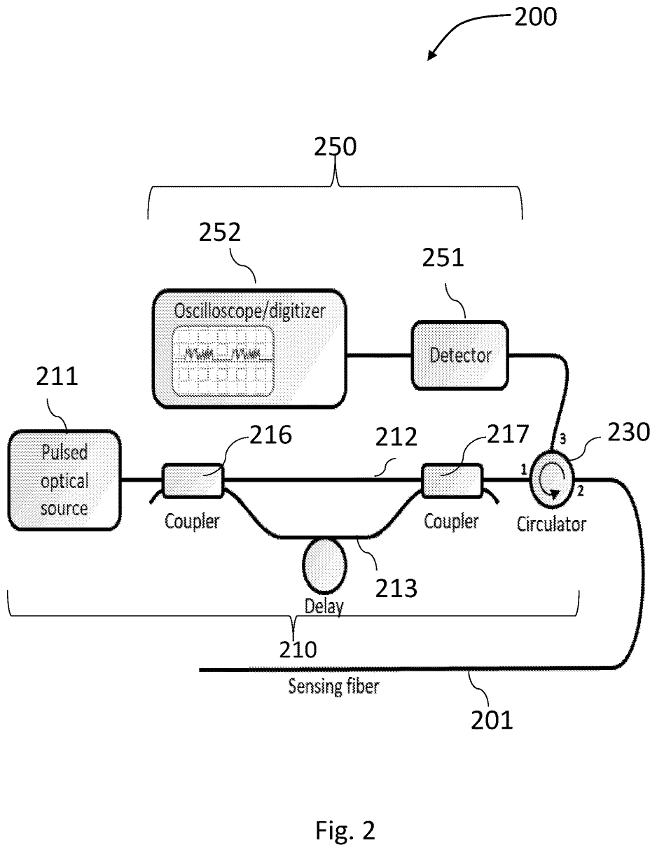

Reference is now made to FIG. 2 schematically illustrating main components of a DAS system 200 that uses two optical fibers of different lengths for generating time-delayed pulses, according to some embodiments. This system 200 may include at least:
a sensing fiber 201;
a pulse generation subsystem 210 that includes at least:
(1) a pulsed optical source 211 such as an externally modulated CW laser, or directly modulated laser;
(2) a first coupler 216, configured connect to the pulsed optical source 211 and optionally also to split the pulsed light emanating from the pulsed optical source 211 into two corresponding pulses: a first pulse and a second pulse, of equivalent (similar or substantially equal) optical characteristics;
(3) a first optical fiber 212 of a length L1 being connectable to and/or extended from the first coupler 216, the first fiber 212 being configured to receive and guide therethrough the first pulse;
(4) a second delay optical fiber 213, of a length L2 which is substantially longer than the length L1 of the first optical fiber 212, and may also be longer than twice the lengths of the sensing fiber 201 “Ls” combined with the length of the first fiber 212 L1, such that

$$L 2 \geq L 1 + 2 L s$$

the second delay optical fiber 213 may be configured for receiving and guiding therethrough the second pulse for time-delaying thereof such as to form a time-difference between the first pulse sand second pulse;
(5) an additional coupler 217 configured to couple the first optical fiber 212 and the second (delay) optical fiber 213;
an optical circulator 230 connectable to three input/exit ports/fibers such that it connects to the sensing fiber 201 at one connecting port, to the second coupler 217 at another (second) connecting port; and
a detection subsystem 250 connectable to the circulator 230 via a third connecting port.

The detection subsystem 250 may include a detector 251 and a data acquisition device 252 such as oscilloscope and/or a digitizer having a processor embedded therein for measuring OTDR based Rayleigh backscattered light properties for each pulse.

According to some embodiments, the time difference Δt between the pulses should satisfy Δt≥2L/ν where L is the overall fiber length and ν is the light velocity in the fiber(s).

The returning Rayleigh profiles of the corresponding pulses may be detected and recorded by the oscilloscope or a digitizer 252 of the detection subsystem 250. Additional processing may be performed on the recorded data (herein sensor data) to find differences between the two differently delayed Rayleigh profiles. The digital processing is based on delaying one profile with respect to the other and taking the difference between the profiles.

According to some embodiments, the digital processing may be based on delaying backscattering Rayleigh profile of one pulse with respect to profile of the other pulse and detecting/identifying the differences therebetween.

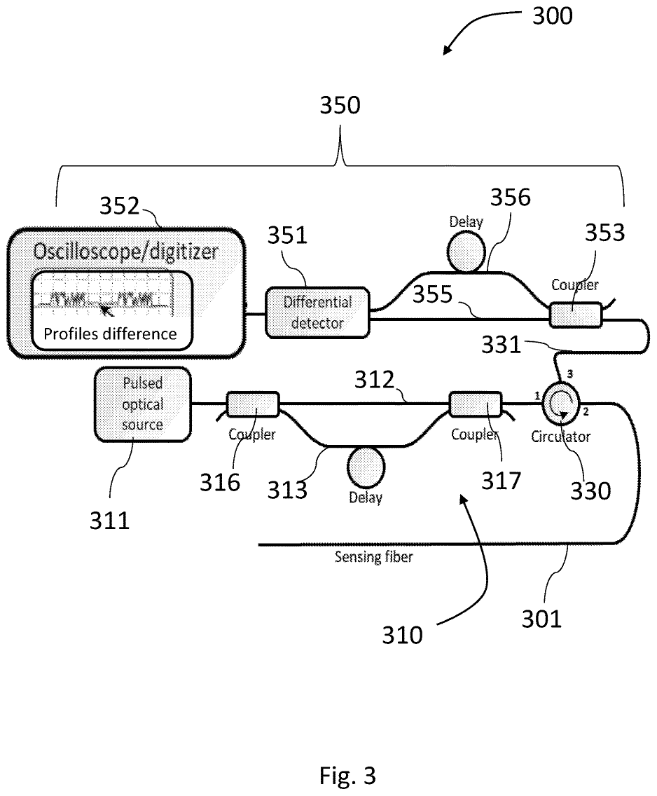

Reference is now made to FIG. 3, schematically illustrating another DAS system 300 that enables dual/differential delaying of the generated pulses, according to some embodiments.

This DAS system 300 includes similar pulses generation subsystem 310 that further delays returning signals, returning from the sensing fiber 301, this system includes:
a pulse generation subsystem 310 including a light source 311 a first optical fiber 312 of length L1 and a second delay optical fiber 313 of length L2 that is longer than L1 and couplers 316 and 317 for splitting the single pulse generated by the source 311 and directing the split pulses each through a different optical fiber 312/313 for generating a first time-delay therebetween Δt1;
the sensing fiber 301;
a circulator 330 connectable to the sensing fiber 301 and the coupler 317 and to an output optical fiber 331;
a detection subsystem 350 including:
(a) a second delay setup including for example, a coupler 353 that connects to the output optical fiber 331 extending from the circulator 330 and enables splitting each light (optical) signal emanating from that output optical fiber 331, which reflects backscattered light of the corresponding pulses, into two different light paths which compensates the delay difference between the two Rayleigh profiles and saves the need for digital compensation. This is done with two different optical fibers of different fiber lengths such as a third optical fiber 355 of a third length L3 and a fourth optical fiber 356 of a fourth length L4 that is longer than L3;
a differential detector 351; and
a data acquisition device 352 such as an oscilloscope or a digitizer.

According to embodiments using the system scheme of FIG. 3, the optical signal has three parts or stages: two Rayleigh profiles which correspond to transmissions in the maximum and minimum delays in the system 300 and, in between, a difference between two Rayleigh profiles which were measured at two different times. As the sensing fiber 301 experiences external perturbation, the difference between the two Rayleigh profiles may change at the location of the perturbation.

Two signals are detected and their corresponding electronic signals are subtracted by the differential detector:
the first signal comprises the response to a pulse which was guided through the (shorter) first fiber 312 and then through the sensing fiber 301 and then was split by the coupler 353 and directed to a (short) fiber 355 (response Pla). It also comprises the response to a pulse which was guided through the (longer) first fiber 313 and then through the sensing fiber 301 and then was split by the coupler 353 and directed to a (short) fiber 355 (response P2a).

The second signal (at the second input of the differential detector) comprises the response to a pulse which was guided through the (shorter) first fiber 312 and then through the sensing fiber 301 and then was split by the coupler 353 and directed to a (longer) fiber 356 (response P1b). It also comprises the response to a pulse which was guided through the (longer) first fiber 313 and then through the sensing fiber 301 and then was split by the coupler 353 and directed to a (long) fiber 356 (response P2b). The first response to arrive to the differential detector is Pla since it corresponds to the shortest path in the system. Similarly, the last response to arrive is P2b. The responses P1b and P2a arrive to the differential detector at the same time and hence the detector output corresponds to their difference. This is the desired part of the signal that we use for sensing.

Since the Rayleigh profiles are polarization-dependent, it may be crucial for the two time-delayed pulses to be of the same polarization direction. Therefore, one or more polarizers may be used to selectively transmit only pulse's light of a same polarization direction or to actively polarize the light of each pulse to the desired/same polarization direction.

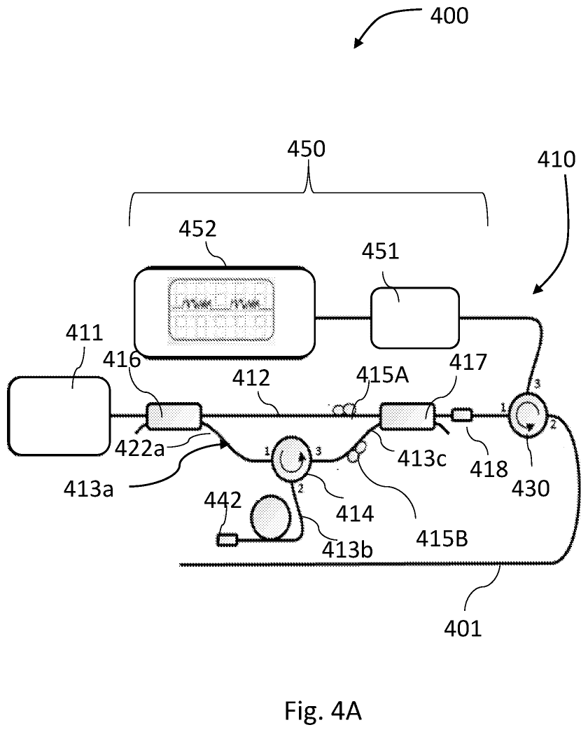

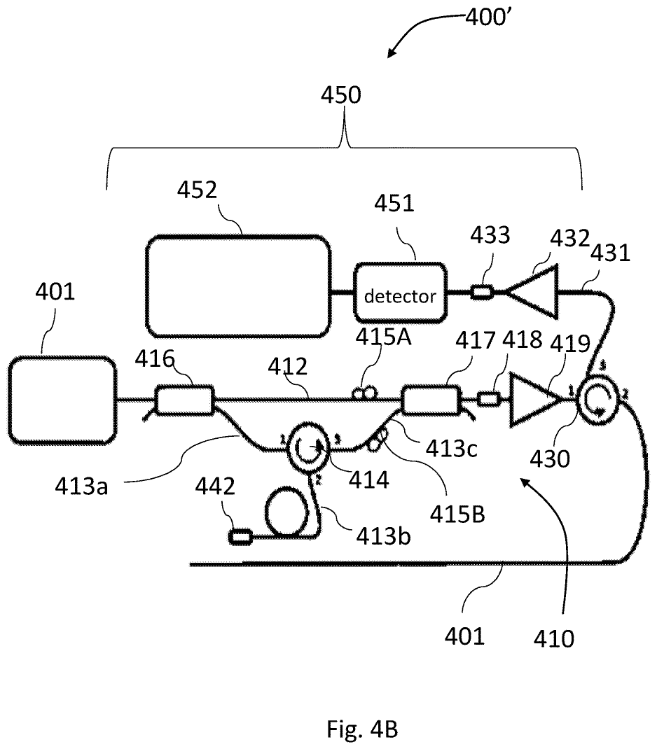

FIGS. 4A and 4B provide two similarly designed DAS systems 400 and 400′ that use a polarizer for ensuring that each of the pulses injected into the sensing fiber 401 is of a same/similar polarization property(ies), according to some embodiments.

The DAS system 400 may include at least:
a pulses generation subsystem 410 including:
a light source 411;
couplers 416 and 417, a first optical fiber 412
a delay module that includes: an optical circulator 414 channeling the second pulse (once directed by the coupler 416) forming three channels channel 413a optically connecting coupler 416 to the circulator 414, a delay optical fiber 413b which forms a second channel, extending from the circulator 414, where the delay fiber 413b has a reflector 442 such as a Faraday reflector (mirror) coupled to a loose edge thereof, and a third channel including another optical fiber 413c connecting the circulator 414 to output coupler 417; and
a detection subsystem 450 including for example a detector 451 and an oscillator 452.

According to some embodiments, as shown in FIGS. 4A and 4B, the pulses generation subsystem 410 may also include one or more polarization controllers such as a first polarization controller 415A coupled to the first optical fiber 412 guiding the first pulse, and a second polarization controller 415B coupled to the optical fiber 413c guiding the delayed second pulse.

According to some embodiments, as shown in FIG. 4B in relation to DAS system 400′, one or more optical amplifiers such as amplification optical fibers e.g., Erbium doped fiber amplifier(s) (EDFA) and the like, can be used to improve signal-to-noise ratio (SNR) e.g. by amplifying the pulses before injected into the sensing fiber 401 (by using a first (booster-type) EDFA 419) and/or amplifying the returning (backscattered) light (e.g., by using a pre-amplifier type EDFA 432 coupled/connected to a fiber 431 emanating from an output port of optical circulator 430).

A filter 433 may be configured and positioned such as to filter out amplified spontaneous emission (ASE) from light outputted from the pre-amplifier EDFA 432. A polarizer 418 may be positioned before the first EDFA 419 to ensure fixed input state of polarization to the sensing fiber.

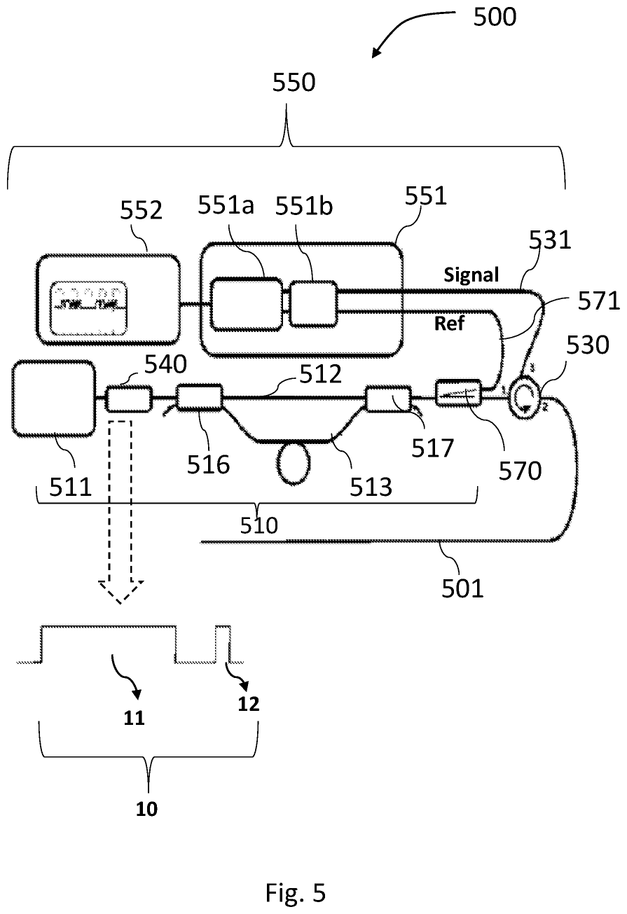

Reference is now made to FIG. 5, schematically illustrating a homodyne DAS system 500 configured for improved DAS performances when utilizing of a broadband light source 511, according to some embodiments.

The homodyne DAS system 500 may include:
a pulse generation subsystem 510 including:
(a) a broadband CW light source 511;
(b) a modulator 540 optically connected to the light source 511 and configured to modulate light emanating from the light source 511 such as to form a waveform 10 having two pulse-parts: a long reference pulse (RP) 11, and a much shorter interrogation pulse (IP) 12; The duration of the short interrogation part of the pulse can be for example 100 ns (to achieve spatial resolution of 10 m). The duration of the long reference pulse will be equal or longer than the duration of the Rayleigh backscattered signal from the sensing fiber. For example, in the case of a sensing fiber of length 5 km the duration of the reference pulse will be equal to or bigger than 50 microseconds.
(c) an unbalanced MZI based delay module including couplers 516 and 517 and first optical fiber 512 and second (delay) optical fiber 513 of different fiber lengths in similar positioning, arrangement and configuration as in DAS system 200 of FIG. 2; and
(d) a fast switch 570 which is located after the second coupler 517 and before the entrance to the sensing fiber 501 via an optical circulator 530, where the fast switch 570 is configured to direct the interrogation pulse 12 into the sensing fiber 501 and the trailing reference pulse 11 to a reference arm/guide 571 of a coherent receiver 551; and
a detection subsystem 550 including an oscillator 552 and the coherent receiver 551. For each of the first and the second (delayed) pulses a beat signal is generated between the reference and the return signal that returns from the sensing fiber 501.

According to some embodiments, the coherent receiver 551 may include a balanced detector 551a and a coupler 551b.

Two beat signals, corresponding to the two delayed versions of the interrogation waveform 10, can be detected. The two detected signals are digitally subtracted, to produce the final outputted sensor data to be analyzed/processed to determine based thereon the one or more properties of the acoustic wave which interacts with the sensing fiber 501 and/or its surrounding environment.

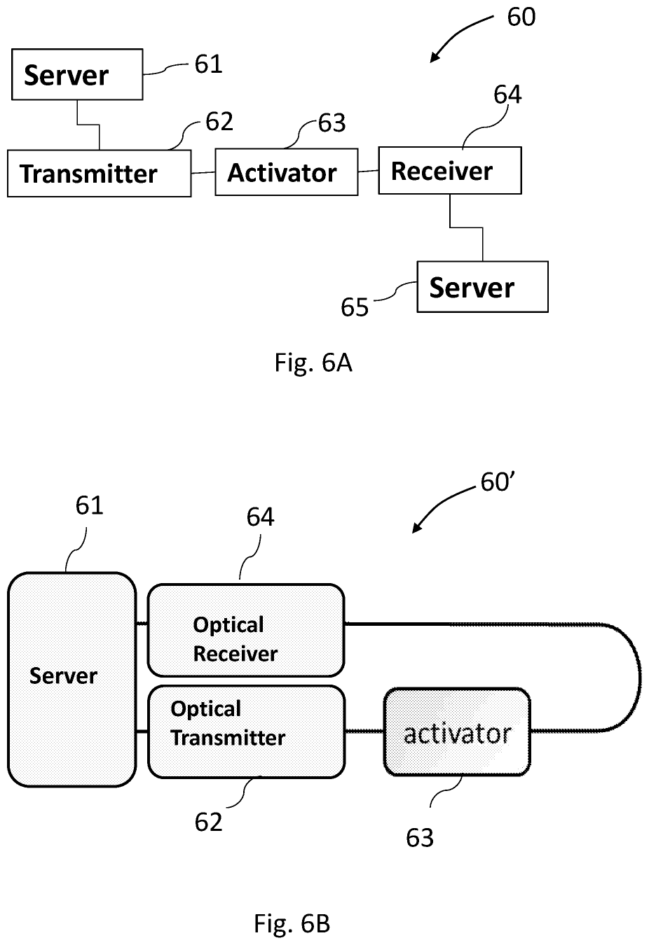

Another approach for implementing DAS using a light source outputting light of a coherence length that is far shorter than the coherence length of common sources in DAS interrogators is described in FIGS. 6A and 6B. The interrogator DAS system 60 comprises:
an optical transmitter 62 and an optical receiver 64. One or more communication servers such as servers 61 and 62 that can transmit digital messages/signals using the optical transmitter 62 and receive them with the optical receiver 64. If the optical path between the transmitter 62 and the receiver 64 does not incur excessive loss or distortion to the messages/signals they will be received with very low Bit Error Rate (BER). We denote the error signal as er(t). It receives a value of 1 if a message is received without errors and 0 in case of errors. The ‘activator’ 63 in the system 60 diagram may include a device which translates a physical parameter we wish to measure into excessive transmission loss. The added loss results in errors and affects er(t). The output of the sensing system is, in this example, the loss signal.

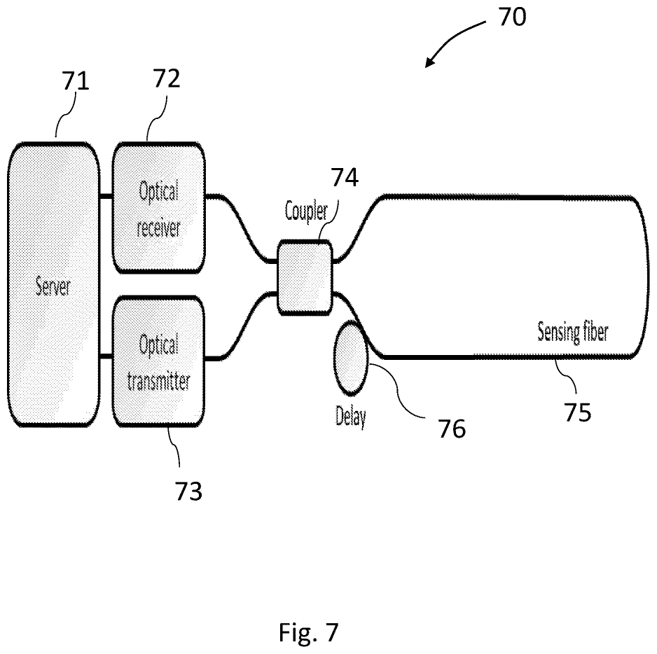

An example of such a sensing system 70 is described in FIG. 7 using a closed-loop of an optical receiver 72, optical transmitter 73 (e.g., operatively associated with a processor such as with a server 71) where the receiver 72 and transmitter 73 connect to one another via a sensing fiber 75 and a coupler 74.

The transmitter 73 launches bit frames into an optical link which is shaped in a Sagnac interferometer configuration. In the absence of external perturbations all the light is returned to the transmitter 83 and er(t)=br where br is the bit rate. An optical delay loop 76 is located over a communication optical line serving as the sensing fiber 75, between the receiver 72 and the transmitter 73. The delay loop 76 introduces an asymmetry between the clockwise circulating light and the counter clockwise circulating light. Therefore, any phase variations in the fiber 75 due to external perturbations will cause light guided by the fiber 75 to reach the receiver 72 and will lead to instances in which the optical signal will be received without error.

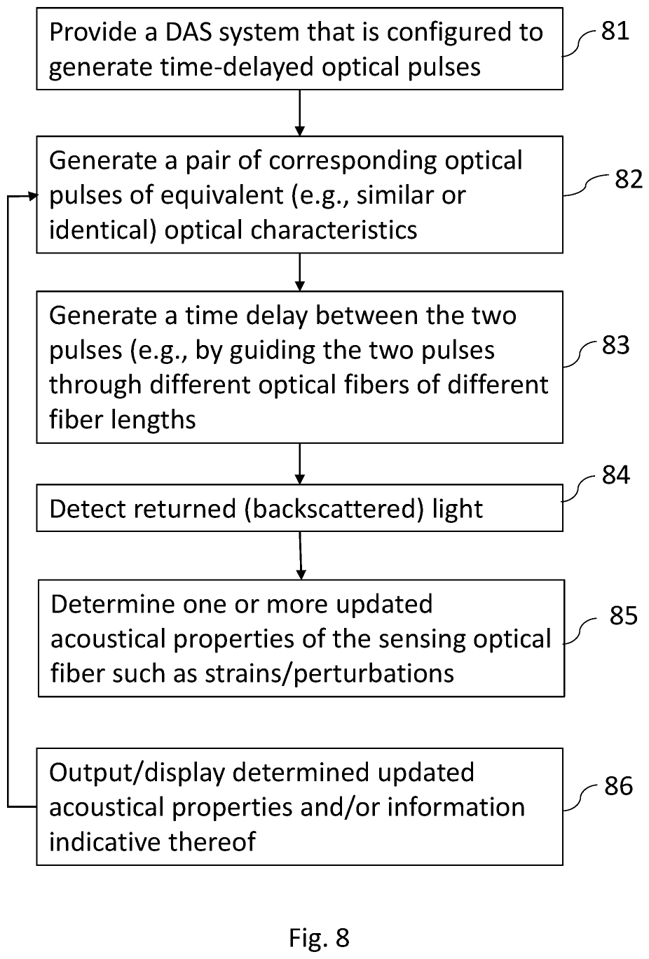

Reference is now made to FIG. 8, schematically illustrating a process/method for distributed acoustic sensing, according to some embodiments. The method/process may include at least the following steps:
(i) providing a DAS system such as any DAS system 100, 200, 300, 400, 400′, 500, 60, 70 as described above that uses two corresponding delayed pulses (step 81);
(ii) generating a pair of corresponding pulses: a first pulse and a second pulse (step 82) of equivalent optical characteristics;
(iii) generating a time-delay Δt between the first pulse and the second pulse (step 83) e.g., by having each of the first and second pulses passed through a different optical fiber of different fiber lengths;
(iv) detecting backscattered light (step 84) using a detection subsystem of the DAS system, including one or more detection devices;
(v) determining one or more updated acoustical properties of the sensing fiber and/or environment thereof, based on the detected backscattered light of the delayed pulses (step 85); and
(vi) (optional) outputting (e.g., by displaying) determined one or more updated acoustical properties of the sensing fiber and/or environment thereof and/or any information associated therewith (step 86).

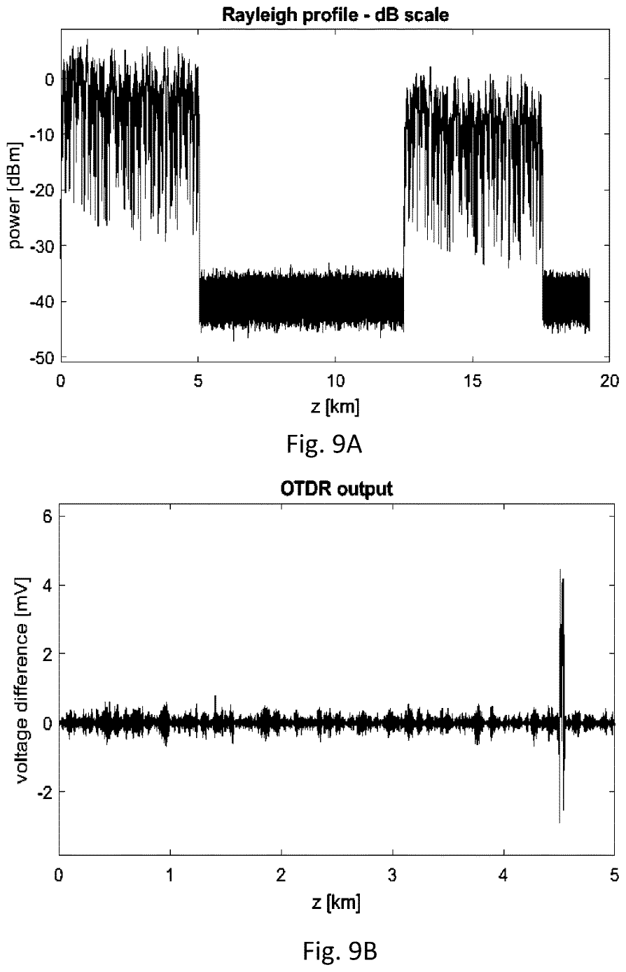

Reference is now made to FIGS. 9A and 9B showing simulated results showing how Rayleigh profiles can be distinguishable when using the delay approach proposed in this document: FIG. 9A shows a the two differently delayed versions of the Rayleigh profile of the sensing fiber; and FIG. 9B shows the difference between the Rayleigh profile of the first pulse and of the second (delayed) pulse (after the delay and the amplitude differences were digitally compensated). The graph shown in FIG. 9B simulates how an external acoustic signal (strain) applied to the sensing fiber at a position of 4.5 Km in the sensing fiber can be easily identified over the “difference signal” graph.

According to some embodiments an optimal delay time can be associated with two limiting effects:
(1) The first limiting effect pertains to the type of sampling that is implemented by the system in respect to the external acoustical signal. The external acoustical signal is sampled at two delayed instances and the difference between the sampling is the observed signal. Namely, denoting the variations in the backscatter signal along the ‘slow time’ axis at a given position in the fiber as a(t) and the observed signal as b(t) the relation between being:

$$b ( t ) = a ( t ) - a ( t - τ ) \qquad ( 0.1 )$$

Where τ=L/ν is the differential time delay of the system L is the length of the delay fiber and ν is the speed of light in the fiber. Hence, the DAS system is responsive to a filtered version of a(t).

In the frequency domain the response of the system can be described as:

$$H ( ω ) = \frac{\vert b ( ω ) {\vert}^{2}}{\vert a ( ω ) {\vert}^{2}} = \vert 1 - {e}^{- j ω τ} {\vert}^{2} = 4 {sin}^{2} ( \frac{ω L}{2 v} ) \qquad ( 0.2 )$$

(2) The second effect is the loss which is experienced by the light in the fiber delay. This optical loss is proportional to exp(−αL/ν) where a is the loss coefficient in the sensing fiber. The signal to noise ratio (SNR) with which an acoustical signal may be detected should satisfy:

$$SNR ∝ {e}^{- 2 α L} {sin}^{2} ( \frac{ω L}{2 v} ) \qquad ( 2.1 )$$

To obtain the delay which gives maximum SNR we should find the first maxima of the expression in Error! Reference source not found. It is found that:

$${L}_{opt} = \frac{2 v}{ω} {tan}^{1} ( \frac{ω}{2 α v} ) \qquad ( 2.2 )$$

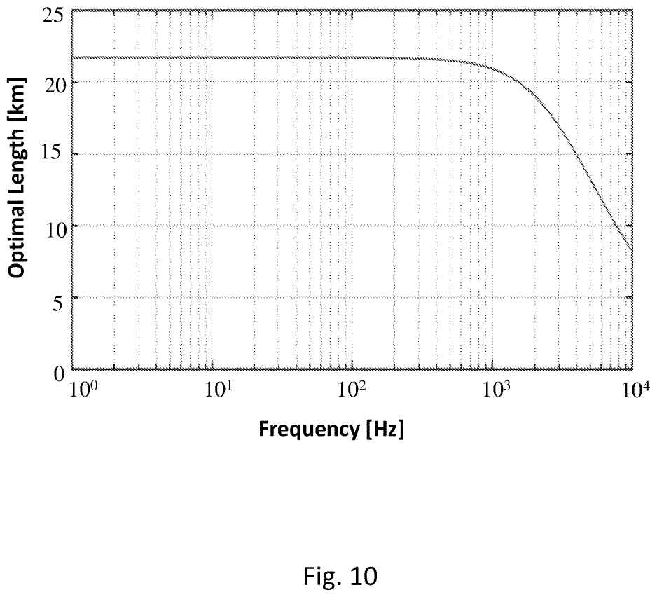

The optimal length Lopt (meaning the optimal lengths difference ΔL causing the delay), is given in equation 2.2 and depends on the frequency as shown in FIG. 10.

### EXAMPLES

Example 1 is a distributed acoustic sensing (DAS) system comprising at least:
(i) a sensing optical fiber;
(ii) a pulse generation subsystem configured to generate, at each scan period, at least two corresponding optical pulses of equivalent optical characteristics comprising at least: a first pulse and a second pulse, which are time delayed from one another such as to form a time difference Δt between the first pulse and the second pulse, wherein the pulse generation subsystem is further configured to direct each generated optical pulse through the sensing optical fiber; and
(iii) a detection subsystem comprising at least one detector, configured and positioned to detect one or more optical characteristics of backscattered light returned from the sensing optical fiber;
(vi) a processor configured at least to determine, based on detected backscattered signals of each of the corresponding pulses, one or more updated properties of one or more acoustic waves influencing the sensing optical fiber.

In example 2, the subject matter of example 1 may include, wherein the pulse generation subsystem comprises at least: (a) an optical source unit comprising one or more optical sources, configured for generating pulses of optical signals; and (b) at least two optical fibers: a first fiber of a first fiber length L1 and a second fiber of a second fiber length L2, wherein the first and second fibers are of different fiber-lengths such that |L2−L1|=ΔL, wherein the generated first pulse of each generated corresponding pair of pulses is directed through the first fiber and the second pulse is directed through the second fiber, for causing the time delay Δt between the two pulses, for detecting one or more backscattering properties thereof.

In example 3, the subject matter of any one or more of examples 1 to 2 may include, wherein the detection subsystem and/or the processor is configured at least to determine Rayleigh profile of the sensing fiber for each of the corresponding pulses at each scan, for determining the one or more updated properties of the acoustic wave which interacts with the sensing fiber.

In example 4, the subject matter of any one or more of examples 1 to 3 may include, wherein the time difference “At” between the first and second pulses is equal to or larger than the time required for the first pulse or for the second pulse, to travel twice the length of the sensing optical fiber such that Δt≥2L/ν, where “L” is the length of the sensing optical fiber and “ν” is the speed of light in the sensing optical fiber.

In example 5, the subject matter of any one or more of examples 1 to 4 may include, wherein the pulse generation subsystem comprises: a single optical light source configured to output pulsed light at a specific wavelength (WL) range; a pulse-splitting subsystem that is configured to split the pulse emanating from the single light source into two corresponding pulses, via an unbalanced Mach Zehnder Interferometer (MZI), forming thereby the corresponding first and second pulses.

In example 6, the subject matter of any one or more of examples 1 to 5 may include, wherein the DAS system further includes one or more optical circulators, at least one of the one or more optical circulators being configured and positioned to direct light emanating from the pulse generation subsystem to and from the sensing optical fiber and to the detection subsystem.

In example 7, the subject matter of any one or more of examples 1 to 6 may include, wherein the detection subsystem comprises: an optical detector; an oscilloscope and/or a digitizer; one or more optical filters; one or more optical amplifiers.

In example 8, the subject matter of any one or more of examples 1 to 7 may include, wherein the DAS system further includes at least one polarizer positioned and configured such as to ensure that both time delayed corresponding first and second pulses are of the same polarization before being launched into the sensing optical fiber.

In example 9, the subject matter of example 8 may include, wherein the DAS system 8 further includes a Faraday mirror coupled to a free end of the delay optical fiber, for reducing polarizations variations therein.

In example 10, the subject matter of any one or more of examples 1 to 9 may include, wherein the DAS system further includes at least one optical amplifier for improving signal-to-noise ratio (SNR).

In example 11, the subject matter of any one or more of examples 1 to 10 may include, wherein the pulse generation subsystem comprises at least one continuous wave (CW) laser light source and at least one corresponding optical modulator for modulating the output light emanating from the at least one CW laser light source.

In example 12, the subject matter of example 11 may include, wherein the optical modulator is configured to generate pulses of at least two types of intensity profiles: a reference pulse and an interrogation pulse that is of a narrower peak width than that of the reference pulse.

In example 13, the subject matter of example 12 may include, wherein the DAS system further includes a fast switch positioned and configured such as to direct the interrogation pulse into the sensing optical fiber and the reference pulse to a coherent receiver of the detection subsystem.

Example 14 is a method for distributed acoustic sensing (DAS), the method comprising at least:
providing a DAS system according to any one or more of claims 1 to 13;
at each scan period;
generating two corresponding pulses: a first pulse and a second pulse, forming a time delay Δt between the two corresponding pulses Δt;
directing each of the first and the second corresponding pulses through the sensing optical fiber;
detecting backscattered signals of each pair of corresponding first and second pulses returning from the sensing optical fiber; and
determining, based on detected backscattering signals of each pair of corresponding pulses, one or more updated properties of the acoustic wave which interacts with the sensing optical fiber.

In example 15, the subject matter of example 14 may include, wherein the forming of the time delay is done by directing the two corresponding pulses through different optical fibers of different fiber lengths, wherein the longer optical fiber is referred to as a delay optical fiber.

In example 16, the subject matter of any one or more of examples 14 to 15 may include, wherein the step of detecting backscattered signals of each pair of corresponding first and second pulses returning from the sensing optical fiber comprises detecting Rayleigh backscattered light.

In example 17, the subject matter of any one or more of examples 15 to 16 may include, wherein a single optical light source configured to output pulsed light at a specific wavelength (WL) range is used for generating the corresponding pulses.

In example 18, the subject matter of example 17 may include, wherein the method further includes the step of splitting the light from the light source into two pulses of equivalent optical characteristics prior to generating a time delay therebetween and then generating the time delay between the two pulses and then directing these two time-delayed pulses through the sensing optical fiber.

In example 19, the subject matter of example 18 may include, wherein the two corresponding pulses are directed through an unbalanced Mach Zehnder Interferometer (MZI), for generating the time delay therebetween.

In example 20, the subject matter of any one or more of examples 15 to 19 may include, wherein an optimal length difference between the two optical fibers ΔLₒₚₜ is proportional to:

$$\frac{2 v}{ω} {tan}^{- 1} ( \frac{ω}{2 α v} ) ,$$

wherein ν is the speed of light within the first and/or the second optical fiber, and a is the loss coefficient of the delay fiber.

Unless specifically stated otherwise, as apparent from the following discussions, it is appreciated that throughout the specification discussions utilizing terms such as “determine”, “deduce”, “analyze”, “process”, “decide”, “receive”, “transmit”, “output”, “identify” etc., and/or any conjugation thereof, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A distributed acoustic sensing (DAS) system comprising at least:
(i) a sensing optical fiber;
(ii) a pulse generation subsystem configured to generate, at each scan period, at least two corresponding optical pulses of equivalent optical characteristics comprising at least: a first pulse and a second pulse, which are time delayed from one another such as to form a time difference Δt between the first pulse and the second pulse, wherein the pulse generation subsystem is further configured to direct each generated optical pulse through the sensing optical fiber; and
(iii) a detection subsystem comprising at least one detector, configured and positioned to detect one or more optical characteristics of backscattered light returned from the sensing optical fiber;
(vi) a processor configured at least to determine, based on detected backscattered signals of each of the corresponding pulses, one or more updated properties of one or more acoustic waves influencing the sensing optical fiber.

2. The DAS system of claim 1, wherein the pulse generation subsystem comprises at least:
(a) an optical source unit comprising one or more optical sources, configured for generating pulses of optical signals; and
(b) at least two optical fibers: a first fiber of a first fiber length L1 and a second fiber of a second fiber length L2, wherein the first and second fibers are of different fiber-lengths such that |L2−L1|=ΔL,
wherein the generated first pulse of each generated corresponding pair of pulses is directed through the first fiber and the second pulse is directed through the second fiber, for causing the time delay Δt between the two pulses, for detecting one or more backscattering properties thereof.

3. The DAS system of claim 1, wherein the detection subsystem and/or the processor is configured at least to determine Rayleigh profile of the sensing fiber for each of the corresponding pulses at each scan, for determining the one or more updated properties of the acoustic wave which interacts with the sensing fiber.

4. The DAS system of claim 1, wherein the time difference “Δt” between the first and second pulses is equal to or larger than the time required for the first pulse or for the second pulse, to travel twice the length of the sensing optical fiber such that Δt≥2L/ν, where “L” is the length of the sensing optical fiber and “ν” is the speed of light in the sensing optical fiber.

5. The DAS system of claim 1, wherein the pulse generation subsystem comprises:
a single optical light source configured to output pulsed light at a specific wavelength (WL) range;
a pulse-splitting subsystem that is configured to split the pulse emanating from the single light source into two corresponding pulses, via an unbalanced Mach Zehnder Interferometer (MZI), forming thereby the corresponding first and second pulses.

6. The DAS system of claim 1 further comprising one or more optical circulators, at least one of the one or more optical circulators being configured and positioned to direct light emanating from the pulse generation subsystem to and from the sensing optical fiber and to the detection subsystem.

7. The DAS system of claim 1, wherein the detection subsystem comprises:
an optical detector;
an oscilloscope or a digitizer;
one or more optical filters;
one or more optical amplifiers.

8. The DAS system of claim 1 further comprising at least one polarizer positioned and configured such as to ensure that both time delayed corresponding first and second pulses are of the same polarization before being launched into the sensing optical fiber.

9. The DAS system of claim 8 further comprising a Faraday mirror coupled to a free end of the delay optical fiber, for reducing polarizations variations therein.

10. The DAS system of claim 1 further comprising at least one optical amplifier for improving signal-to-noise ratio (SNR).

11. The DAS system of claim 1, wherein the pulse generation subsystem comprises at least one continuous wave (CW) laser light source and at least one corresponding optical modulator for modulating the output light emanating from the at least one CW laser light source.

12. The DAS system of claim 11, wherein the optical modulator is configured to generate pulses of at least two types of intensity profiles: a reference pulse and an interrogation pulse that is of a narrower peak width than that of the reference pulse.

13. The DAS system of claim 12 further comprising a fast switch positioned and configured such as to direct the interrogation pulse into the sensing optical fiber and the reference pulse to a coherent receiver of the detection subsystem.

14. A method for distributed acoustic sensing (DAS), the method comprising at least:
providing a DAS system according to claim 1; at each scan period:
generating two corresponding pulses: a first pulse and a second pulse,
forming a time delay Δt between the two corresponding pulses Δt;
directing each of the first and the second corresponding pulses through the sensing optical fiber;
detecting backscattered signals of each pair of corresponding first and second pulses returning from the sensing optical fiber; and
determining, based on detected backscattering signals of each pair of corresponding pulses, one or more updated properties of the acoustic wave which interacts with the sensing optical fiber.

15. The method of claim 14, wherein the forming of the time delay is done by directing the two corresponding pulses through different optical fibers of different fiber lengths, wherein the longer optical fiber is referred to as a delay optical fiber.

16. The method of claim 14, wherein the step of detecting backscattered signals of each pair of corresponding first and second pulses returning from the sensing optical fiber comprises detecting Rayleigh backscattered light.

17. The method of claim 15, wherein a single optical light source configured to output pulsed light at a specific wavelength (WL) range is used for generating both corresponding pulses.

18. The method of claim 17 further comprising splitting the light from the light source into two pulses of equivalent optical characteristics prior to generating a time delay therebetween and then generating the time delay between the two pulses and then directing these two time-delayed pulses through the sensing optical fiber.

19. The method of claim 18, wherein the two corresponding pulses are directed through an unbalanced Mach Zehnder Interferometer (MZI), for generating the time delay therebetween.

20. The method of claim 15, wherein an optimal length difference between the two optical fibers ΔLₒₚₜ is proportional to:
$$\frac{2 v}{ω} {tan}^{- 1} ( \frac{ω}{2 α v} ) ,$$
wherein ν is the speed of light within the first and/or the second optical fiber, and α is the loss coefficient of the delay fiber.
